(19) United States
(12) Patent Application Publication
(10) Pub. No.: US 2024/0275293 A1
(43) Pub. Date: Aug. 15, 2024

(54) POWER SUPPLY SYSTEM WITH ACTIVE CLAMPING

(71) Applicant: TEXAS INSTRUMENTS INCORPORATED, DALLAS, TX (US)

(72) Inventor: Isaac COHEN, DIX HILLS, NY (US)

(21) Appl. No.: 18/169,152

(22) Filed: Feb. 14, 2023

(51) Int. Cl. H02M 3/335; H02M 1/08

(52) U.S. Cl. CPC H02M 3/33573; H02M 1/08

(57) ABSTRACT

One example includes a circuit. The circuit includes a rectifier having a rectifier output and an active clamp circuit having a control input, a clamp circuit input, and a clamp circuit output. The clamp circuit input can be coupled to the rectifier output and the clamp circuit output can be coupled to an output of the circuit. The circuit also includes a drive circuit having a drive output coupled to the control input.

### TECHNICAL FIELD

This description relates generally to electronic circuits, and more particularly to a power supply system with active clamping.

### BACKGROUND

Power supply circuits can be implemented in a variety of different ways. Examples of power supply circuits include synchronous rectifier power converters, asynchronous rectifier power converters, resonant power converters, and any of a variety of other types of switching power converters. A typical power supply circuit can thus activate one or more switches to convert an input voltage to an output voltage. Typical power supply circuits can implement a transformer for delivering an output voltage on the secondary winding of a transformer from a square-wave input voltage applied by the switches to the primary winding of the transformer. Based on the resonant characteristics between the windings of the transformer and circuit component parasitic effects, the current in the primary and secondary windings can exhibit ringing, which can result in an induced voltage ringing on both input switches and output switches.

### SUMMARY

One example includes a circuit that includes a rectifier having a rectifier output and an active clamp circuit having a control input, a clamp circuit input, and a clamp circuit output. The clamp circuit input can be coupled to the rectifier output and the clamp circuit output can be coupled to an output of the circuit. The circuit also includes a drive circuit having a drive output coupled to the control input.

Another example includes a circuit that includes a rectifier having a rectifier output and a clamping diode having a clamping anode and a clamping cathode. The clamping anode can be coupled to the rectifier output. The circuit also includes a clamping capacitor having a first capacitor terminal and a second capacitor terminal. The first capacitor terminal can be coupled to the clamping cathode and the second capacitor terminal can be coupled to an output of the circuit. The circuit also includes a flyback converter. The flyback converter includes a clamping inductor having a first inductor terminal and a second inductor terminal. The first inductor terminal can be coupled to the output of the circuit and the second inductor terminal can be coupled to a clamping switch output. The flyback converter also includes a clamping switch having a control input, a switch input, and a switch output. The switch input can be coupled to the clamping cathode and the switch output coupled to the second inductor terminal. The flyback converter further includes a flyback diode having a flyback anode and a flyback cathode. The flyback anode can be coupled to an input voltage terminal and the flyback cathode can be coupled to the clamping switch output.

Another example includes a circuit that includes a switching stage having a switching stage input and a switching stage output and a switching controller having a controller output coupled to the switching stage input. The circuit also includes a transformer having a transformer input and first and second transformer outputs. The transformer input can be coupled to the controller output. The circuit also includes a rectifier having a first rectifier input, a second rectifier input, and a rectifier output. The first and second rectifier inputs can be coupled to the first and second transformer outputs. The circuit further includes an active clamp circuit having a control input, a clamp circuit input, and a clamp circuit output. The clamp circuit input can be coupled to the rectifier output and the clamp circuit output is coupled to an output of the circuit. The circuit further includes a drive circuit having a drive output coupled to the control input.

### BRIEF DESCRIPTION OF THE DRAWINGS

FIG. 1 is a block diagram of a power supply system.

FIG. 2 is an example circuit diagram of a power supply circuit.

FIG. 3 is another example circuit diagram of a power supply circuit.

FIG. 4 is yet another example circuit diagram of a power supply circuit.

### DETAILED DESCRIPTION

This description relates generally to electronic circuits, and more particularly to a power supply system with active clamping. The power supply system includes a switching stage, a rectifier stage, a transformer interconnecting the switching and rectifier stages, and a switching controller. The switching stage includes a set of input switches that are alternately activated to provide a primary current through a primary winding of the transformer. As described herein, the term “activate”, as describing a transistor, refers to providing sufficient bias (e.g., gate-source voltage for a field-effect transistor (FET)) to operate the transistor device in resistive mode. Similarly, the term “deactivate”, as describing a transistor, refers to removing bias to operate the transistor device in cutoff mode. As an example, the switching stage can be arranged as a full-bridge switching stage that includes a set of input four switches, with alternate pairs of the input switches being activated to provide the primary current through the primary winding of the transformer. The rectifier stage includes a rectifier (e.g., a set of diodes) to rectify a secondary current that is induced in the secondary winding of the transformer and is provided to an output to provide an output voltage to a load. As an example, the rectifier stage can be arranged as a full-bridge or a half-bridge rectifier stage, and can include a set of output switches instead of diodes to provide rectification (e.g., in response to switching signals provided from the switching controller).

The rectifier stage also includes an active clamping circuit. As an example, the active clamping circuit includes a clamping diode, a clamping capacitor, and a clamping current path circuit. The clamping diode can be coupled to the rectifier and the clamping capacitor can be arranged between a cathode of the clamping diode and the output to store a charge that provides a clamping voltage. As an example, the voltage provided on the secondary of the transformer can be equal to approximately twice a voltage across the primary of the transformer. Therefore, the voltage in excess of the output voltage that is provided at the secondary of the transformer, and thus across the rectifier, can be stored in the clamping capacitor.

The clamping current path circuit can provide a clamping current associated with the clamping voltage to the output of the rectifier stage. Therefore, the power provided at the rectifier stage can be conserved by delivering the power of the clamping capacitor to an output capacitor at the rectifier stage. As an example, the clamping current path circuit can be configured as a flyback converter that includes a clamping switch, a flyback inductor, and a flyback diode. The clamping switch is activated to couple the clamping capacitor to the flyback inductor, thereby transferring the energy delivered to the clamping capacitor through the flyback inductor and then to the output when the clamping switch is turned off. In response to deactivation of the clamping switch, the flyback diode conducts the flyback current (e.g., from ground) through the flyback inductor to the output. The clamping switch can be activated at a fixed frequency, such as proportional to the frequency of the switching of the input switches in the switching stage.

In addition to conserving the excess power across the rectifier, the active clamp circuit can reduce the amplitude of voltage ringing on the rectifier stage. Therefore, circuit devices that are implemented for rectification can be selected to have a lower voltage rating, thereby resulting in a lower voltage drop across the rectifier devices during conduction. As a result, the power loss associated with the rectification can be reduced to provide for more efficient operation of the power supply system.

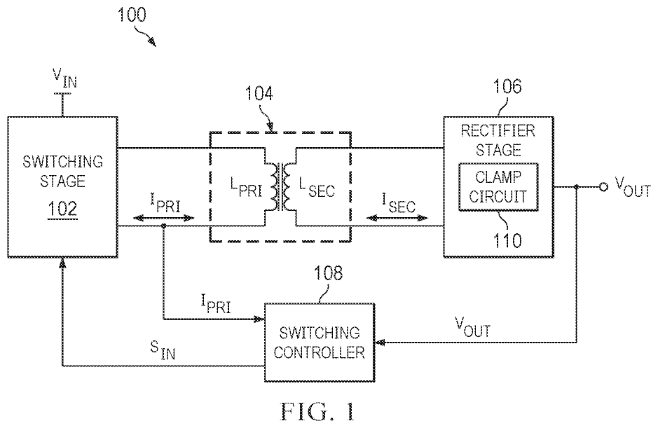

FIG. 1 is a block diagram of a power supply system 100. The power supply system 100 can be configured to generate an output voltage V_{OUT} based on an input voltage V_{IN}. The power supply system 100 can be implemented in any of a variety of direct current (DC) power-providing applications.

The power supply system 100 includes a switching stage 102, a rectifier stage 104, a transformer 106, and a switching controller 108. The switching stage 102 includes a set of input switches that are alternately activated responsive to a respective set of input switching signals S_{IN} to provide a primary current I_{PRI} through a primary winding L_{PRI} of the transformer 106. As an example, the switching stage 102 can be arranged as a full-bridge switching stage that includes a set of input four switches, with alternate pairs of the input switches being activated to provide the primary current I_{PRI} through the primary winding L_{PRI} of the transformer 106. The rectifier stage 104 includes a rectifier that can be arranged as a set of diodes or output switches to rectify a secondary current I_{SEC} that is induced in the secondary winding L_{SEC} of the transformer 106 and is provided to an output to provide the output voltage V_{OUT} to a load. As an example, the rectifier stage 104 can be arranged as a full-bridge rectifier stage that includes a set of four diodes to rectify the secondary current I_{SEC} provided from the secondary winding L_{SEC} of the transformer 106.

In the example of FIG. 1, the rectifier stage 104 further comprises an active clamping circuit 110 (“CLAMP CIRCUIT”). The active clamping circuit 110 can include a clamping diode, a clamping capacitor, and a clamping current path circuit. The clamping diode can be coupled to the rectifier (e.g., the rectifier diodes) and the clamping capacitor can be arranged between a cathode of the clamping diode and the output of the rectifier stage 104 to store a charge that provides a clamping voltage across the clamping capacitor. The active clamping circuit 110 can thus deliver the energy associated with the clamping voltage of the clamping capacitor to the output of the power supply system 100, as described in greater detail herein.

As an example, for a unity turns-ratio of a transformer of a typical switching power supply system, the voltage on the secondary winding of the transformer, and thus the voltage across the rectifier of an associated rectifier stage, can ring and can have a maximum amplitude that is approximately twice a voltage across the primary winding of the transformer. However, by including the active clamping circuit 110 in the power supply system 100, the voltage across the rectifier of the rectifier stage 104 can be clamped to an amplitude that is only slightly greater than the voltage across the primary winding L_{PRI} of the transformer 106, thereby reducing the voltage stress across the rectifier of the rectifier stage 104. However, as described above, the active clamping circuit 110 can deliver the power associated with the clamping voltage of the clamping capacitor to the output of the power supply system 100. Therefore, unlike a typical passive clamping circuit (e.g., that implements a Zener diode), the active clamping circuit 110 can provide clamping of the voltage across the rectifier in a manner that does not result in substantial power dissipation through the passive clamping device(s).

The clamping current path circuit of the active clamping circuit 110 can provide a clamping current associated with the clamping voltage from the clamping capacitor to the output of the rectifier stage 104 in a lossless manner. Therefore, the energy delivered to the clamping capacitor can be transferred to the output (e.g., to the output capacitor) at the rectifier stage 104. As an example, the clamping current path circuit can be configured as a flyback converter that includes a clamping switch, a flyback inductor, and a flyback diode. The clamping switch is activated to couple the clamping capacitor to the flyback inductor, such that the flyback inductor extracts the energy stored in the clamping capacitor as the clamping current is provided to the output. In response to deactivation of the clamping switch, the flyback diode conducts the flyback current (e.g., from ground) through the flyback inductor to the output of the rectifier stage 104. The clamping switch can be activated at a fixed frequency, such as proportional to the frequency of the switching of the input switches in the switching stage.

A flyback converter is but one example of the clamping current path circuit, such that other examples of the clamping current path circuit can be implemented to provide the clamping current to the output of the rectifier stage 104. As an example, other arrangements of switches and/or resistive/inductive current paths can instead be implemented to provide the clamping current to the output of the rectifier stage 104. Furthermore, by clamping the voltage to the output of the rectifier stage 104, the amplitude of the voltage ringing on the rectifier stage 104 can be reduced substantially. Given that voltage ringing is a source of electromagnetic interference (EMI), reduction of amplitude of voltage ringing can improve the performance of the power supply system 100.

As an example, the switching controller 108 can be arranged in or as part of an integrated circuit (IC). The switching controller 108 is configured to generate the input switching signals S_{IN}. In the example of FIG. 1, the switching controller 108 receives the output voltage V_{OUT} as an input, so the switching controller 108 can control the activation of the input switches in the switching stage 102 based on the input switching signals S_{IN} in response to the output voltage V_{OUT} (e.g., in a pulse-width modulation (PWM) scheme).

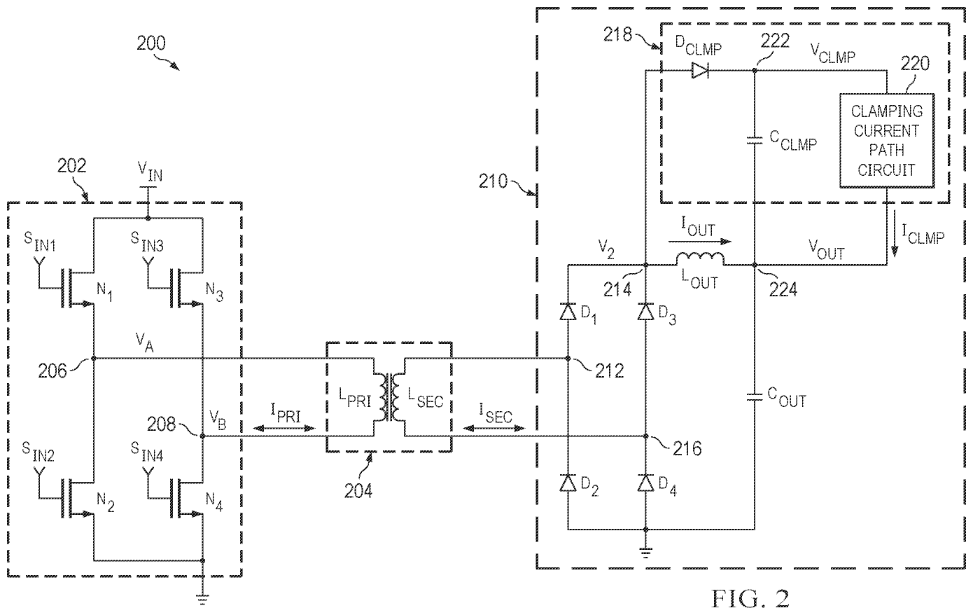

FIG. 2 is an example of a circuit diagram of a power supply system 200. The power supply system 200 can be configured to generate an output voltage V_{OUT} based on an input voltage V_{IN}. The power supply system 200 can be used to implement the power supply system 100 in the example of FIG. 1. Therefore, reference is to be made to the example of FIG. 1 in the following description of the example of FIG. 2.

The power supply system 200 includes a switching stage 202 and a transformer 204. In the example of FIG. 2, the transformer 204 includes a primary winding L_{PRI} and a secondary winding L_{SEC} that are inductively coupled. The switching stage 202 includes a first input switch N₁, a second input switch N₂, a third input switch N₃, and a fourth input switch N₄ that are formed as a full-bridge. In the example of FIG. 2, the input switches N₁, N₂, N₃, and N₄ are demonstrated as N-channel metal-oxide semiconductor field-effect transistors (MOSFETS). The first input switch N₁ is arranged as a first high-side switch that interconnects the input voltage V_{IN} and a first terminal 206 that is coupled to the transformer 204. The second input switch N₂ is arranged as a first low-side switch that interconnects a low voltage rail (e.g., a ground terminal) and the first terminal 206. The third input switch N₃ is arranged as a second high-side switch that interconnects the input voltage V_{IN} and a second terminal 208 that is coupled to the primary winding L_{PRI} of the transformer 204. The fourth input switch N₄ is arranged as a second low-side switch that interconnects the low voltage rail and the second terminal 208. In the example of FIG. 2, the terminal 206 has a voltage V_{A} and the second terminal 208 has a voltage V_{B}, so the primary winding L_{PRI} and the resonant inductor L_{RES} have a voltage V_{AB}.

The first and fourth input switches N₁ and N₄ and the second and third input switches N₂ and N₃ are alternately activated to provide the primary current I_{PRI} in opposing polarities through the primary winding L_{PRI} of the transformer 204. During a first time duration, the first input switch N₁ is activated responsive to a first input switching signal S_{IN1} and the fourth input switch N₄ is activated responsive to a fourth input switching signal S_{IN4}. Therefore, during the first time duration, the primary current I_{PRI} is provided from the input voltage V_{IN}, through the first input switch N₁, through the resonant inductor L_{RES}, through the primary winding L_{PRI} in a first polarity, through the fourth input switch N₄, to the low-voltage rail. As an example, the input switching signals S_{IN1} and S_{IN4} can be staggered to provide for a staggered activation of the respective input switches N₁ and N₄ to control the primary current I_{PRI} through the primary winding L_{PRI}.

During a second time duration, the second input switch N₂ is activated responsive to second input switching signal S_{IN2} and the third input switch N₃ is activated responsive to third input switching signal S_{IN3}. Therefore, during the second time duration, the primary current I_{PRI} is provided from the input voltage V_{IN}, through the third input switch N₃, through the primary winding L_{PRI} in a second polarity opposite the first polarity, through the resonant inductor L_{RES}, through the second input switch N₂, to the low-voltage rail. As an example, the input switching signals S_{IN1} and S_{IN4} can be staggered to provide for a staggered activation of the respective input switches N₁ and N₄ to control the primary current I_{PRI} through the primary winding L_{PRI}. As an example, the input switching signals S_{IN1}, S_{IN2}, S_{IN3}, and S_{IN4} can be provided from a switching controller (e.g., the switching controller 108). The first input switching signal S_{IN1} and the second input switching signal S_{IN2} can be separated by a switching dead-time during which neither of the respective input switches N₁ and N₂ are activated. Similarly, the third input switching signal S_{IN3} and the fourth input switching signal S_{IN4} can be separated by a switching dead-time during which neither of the respective input switches N₃ and N₄ are activated

The power supply system 200 also includes a rectifier stage 210. The rectifier stage 210 includes a first rectifier diode D₁, a second rectifier diode D₂, a third rectifier diode D₃, and a fourth rectifier diode D₄ that are formed as a full-bridge rectifier. The first rectifier diode D₁ interconnects (anode to cathode) a terminal 212 that is coupled to the secondary winding L_{SEC} of the transformer 204 and a terminal 214. The terminal 214 is also coupled to an output inductor L_{OUT} that is configured to conduct an output current I_{OUT}. The second rectifier diode D₂ interconnects the terminal 212 and a low-voltage rail (e.g., a ground terminal). The third rectifier diode D₃ interconnects a terminal 216 that is coupled to the secondary winding L_{SEC} of the transformer 204 and the terminal 214. The fourth rectifier diode D₄ interconnects the low voltage rail and the terminal 216.

The first and fourth rectifier diodes D₁ and D₄ and the second and third rectifier diodes D₂ and D₃ alternately conduct the secondary current I_{SEC} from the secondary winding L_{SEC} to the output inductor L_{OUT}. During a first time duration, the first rectifier diode D₁ and the fourth rectifier diode D₄ conduct the secondary current I_{SEC} from the secondary winding L_{SEC}. Therefore, during the first time duration, the secondary current I_{SEC} is provided as a first rectifier current I_{SR1} from the low voltage rail, through the fourth rectifier diode D₄, through the secondary winding L_{SEC} in a first polarity, and through the first rectifier diode D₁ to the terminal 212. During a second time duration, the third rectifier diode D₃ and the second rectifier diode D₂ conduct the secondary current I_{SEC} from the secondary winding L_{SEC}. Therefore, during the second time duration, the secondary current I_{SEC} is provided as a second rectifier current I_{SR2} from the low voltage rail, through the second rectifier diode D₂, through the secondary winding L_{SEC} in a second polarity opposite the first polarity, through the third rectifier diode D₃, to the terminal 212. The first and second time durations of the rectifier stage 210 can approximately coincide with first and second time durations of the switching stage 202, respectively. The secondary current I_{SEC} can thus be provided through the output inductor L_{OUT} to provide an output voltage V_{OUT} across an output capacitor C_{OUT} based on a voltage V₂ at the terminal 214 at the output of the rectifier diodes D₁ and D₃. The output voltage V_{OUT} can thus power a load (not shown).

In the example of FIG. 2, the rectifier stage 210 further comprises an active clamping circuit 218 that includes a clamping diode D_{CLMP}, a clamping capacitor C_{CLMP}, and a clamping current path circuit 220. The clamping diode D_{CLMP} is arranged to interconnect the terminal 216 and a terminal 222. Both the clamping capacitor C_{CLMP} and the clamping current path circuit 220 interconnect the terminal 222 and an output 224 of the rectifier stage 210.

As described above, for a unity turns-ratio of a transformer of a typical switching power supply system, the voltage on the secondary winding of the transformer, and thus the voltage across the rectifier of an associated rectifier stage, can ring and can have a maximum amplitude that is approximately twice a voltage across the primary winding of the transformer. However, in the power supply system 200, the active clamping circuit 218 can clamp the maximum amplitude of the voltage V₂ to approximately equal to the voltage across the primary winding L_{PRI} of the transformer 204. The voltage V₂ can be delivered to the output 224 via the output inductor L_{OUT} and can be provided to the clamping capacitor C_{CLMP} via the clamping diode D_{CLMP}, thus providing a clamping voltage V_{CLMP} on the clamping capacitor C_{CLMP}. As an example, the clamping capacitor C_{CLMP} can have a capacitance that is sufficiently large to provide the clamping voltage V_{CLMP} as substantially constant despite the ringing of the voltage V₂.

The clamping current path circuit 220 is configured to provide a clamping current I_{CLMP} from the terminal 222 to the output 224 based on the clamping voltage V_{CLMP}. As an example, the clamping current path circuit 220 can provide the clamping current I_{CLMP} from the terminal 222 to the output 224 in an approximately lossless manner. Therefore, instead of dissipating the energy of the clamped voltage V₂, such as provided by a passive clamping circuit device (e.g., a Zener diode) in a typical power supply system, the clamped energy can instead be conserved and delivered to the output 224 of the rectifier stage 210 to be used for the load. Thus, the clamping current path circuit 220 can be modeled as a synthetic resistor to provide the clamping current from the clamping capacitor C_{CLMP} to the output 224. The resistance value of such a synthetic resistor can be set based on the component characteristics of the clamping current path circuit 220 to balance the energy provided to and from the clamping capacitor C_{CLMP} regardless of the operation of the power supply system 200, and thus the amplitude of the voltage V₂, as described in greater detail herein. Accordingly, the clamping current path circuit 220 can provide self-regulation of the clamping voltage V_{CLMP} in providing the clamping current I_{CLMP} to the output 224.

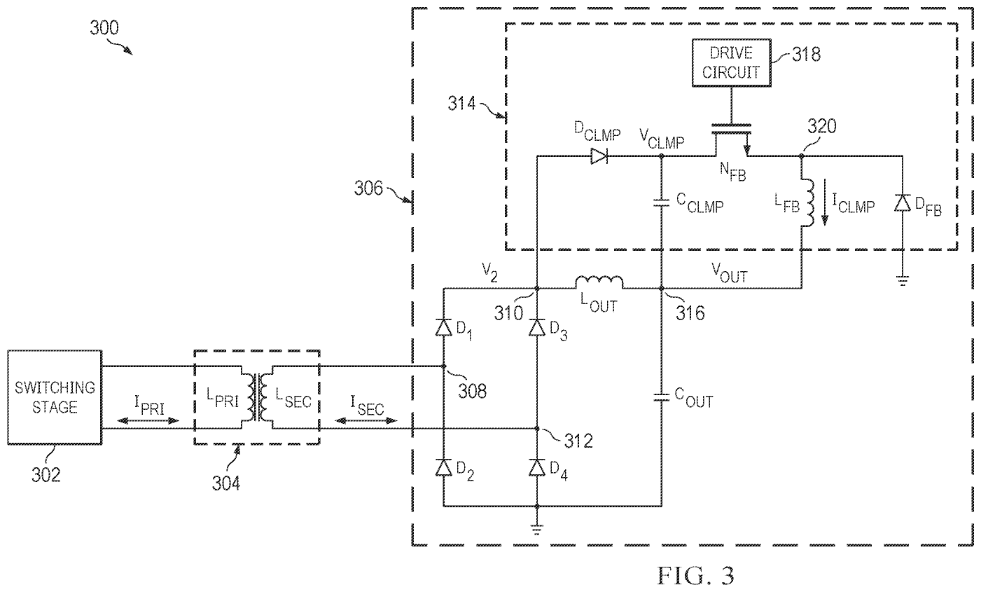

FIG. 3 is another example of a circuit diagram of a power supply system 300. The power supply system 300 can be configured to generate an output voltage V_{OUT} based on an input voltage V_{IN}. The power supply system 300 can be used to implement the power supply system 100 in the example of FIG. 1. Therefore, reference is to be made to the example of FIG. 1 in the following description of the example of FIG. 3.

The power supply system 300 includes a switching stage 302 and a transformer 304. The switching stage 302 can be arranged substantially similar to the switching stage 202 in the example of FIG. 2. Therefore, the switching stage 302 can be arranged as a full bridge switching stage that includes four input switches that are alternately activated in pairs to provide the primary current I_{PRI} through the primary winding L_{PRI} of the transformer 304 in a first direction during a first time duration and in a second direction during a second time duration.

The power supply system 300 also includes a rectifier stage 306. Similar to the rectifier stage 210 in the example of FIG. 2, the rectifier stage 306 includes a first rectifier diode D₁, a second rectifier diode D₂, a third rectifier diode D₃, and a fourth rectifier diode D₄ that are formed as a full-bridge rectifier. The first rectifier diode D₁ interconnects (anode to cathode) a terminal 308 that is coupled to the secondary winding L_{SEC} of the transformer 304 and a terminal 310. The terminal 310 is also coupled to an output inductor L_{OUT} that is configured to conduct an output current I_{OUT}. The second rectifier diode D₂ interconnects the terminal 308 and a low-voltage rail (e.g., a ground terminal). The third rectifier diode D₃ interconnects a terminal 312 that is coupled to the secondary winding L_{SEC} of the transformer 304 and the terminal 310. The fourth rectifier diode D₄ interconnects the low voltage rail and the terminal 308.

The first and fourth rectifier diodes D₁ and D₄ and the second and third rectifier diodes D₂ and D₃ alternately conduct the secondary current I_{SEC} from the secondary winding L_{SEC} to the output inductor L_{OUT}. During a first time duration, the first rectifier diode D₁ and the fourth rectifier diode D₄ conduct the secondary current I_{SEC} from the secondary winding L_{SEC}. Therefore, during the first time duration, the secondary current I_{SEC} is provided as a first rectifier current I_{SR1} from the low voltage rail, through the fourth rectifier diode D₄, through the secondary winding L_{SEC} in a first polarity, and through the first rectifier diode D₁ to the terminal 308. During a second time duration, the third rectifier diode D₃ and the second rectifier diode D₂ conduct the secondary current I_{SEC} from the secondary winding L_{SEC}. Therefore, during the second time duration, the secondary current I_{SEC} is provided as a second rectifier current I_{SR2} from the low voltage rail, through the second rectifier diode D₂, through the secondary winding L_{SEC} in a second polarity opposite the first polarity, through the third rectifier diode D₃, to the terminal 308. The first and second time durations of the rectifier stage 306 can approximately coincide with first and second time durations of the switching stage 302, respectively. The secondary current I_{SEC} can thus be provided through the output inductor L_{OUT} to provide an output voltage V_{OUT} across an output capacitor C_{OUT}. The output voltage V_{OUT} can thus power a load (not shown).

In the example of FIG. 3, the rectifier stage 306 further comprises an active clamping circuit 314 that includes a clamping diode D_{CLMP}, a clamping capacitor C_{CLMP}, and a clamping current path circuit, demonstrated in the example of FIG. 3 as a flyback converter. The clamping diode D_{CLMP} is arranged to interconnect the terminal 308 and a terminal 310, and the clamping capacitor C_{CLMP} interconnects the terminal 310 and an output 316 of the rectifier stage 306. The flyback converter includes a clamping switch N_{FB}, a flyback inductor L_{FB}, a flyback diode D_{FB}, and a drive circuit 318. The clamping switch N_{FB} is demonstrated in the example of FIG. 3 as an N-FET coupled between the terminal 310 and a terminal 320, the flyback inductor L_{FB} is coupled between the terminal 320 and an output 316 of the rectifier stage 306, and the flyback diode D_{FB} interconnects a low-voltage rail (e.g., ground) and the terminal 320. The drive circuit 318 is configured to control the activation of the clamping switch N_{FB} via an activation signal ACT.

As described above, the active clamping circuit 314 can clamp the maximum amplitude of the voltage V₂ to approximately equal to the voltage across the primary winding L_{PRI} of the transformer 204. The voltage V₂ can be delivered to the output 316 via the output inductor L_{OUT} and can be provided to the clamping capacitor C_{CLMP} via the clamping diode D_{CLMP}, thus providing a clamping voltage V_{CLMP} on the clamping capacitor C_{CLMP}.

The flyback converter is configured to provide a clamping current I_{CLMP} from the terminal 310 to the output 316 based on the clamping voltage V_{CLMP}. In the example of FIG. 3, the clamping switch N_{FB} is periodically activated, such as at a fixed on-time, by the activation signal ACT provided from the drive circuit 318 to provide a clamping current I_{CLMP} from the terminal 310 to the output 316 through the flyback inductor L_{FB}. When the clamping switch is deactivated, the clamping current I_{CLMP} is maintained through the flyback inductor L_{FB}, thus providing forward bias conduction of the clamping current I_{CLMP} from the low-voltage rail through the flyback diode D_{FB}. Therefore, instead of dissipating the energy of the clamped voltage V₂, such as provided by a passive clamping circuit device (e.g., a Zener diode) in a typical power supply system, the clamped energy can instead be conserved and delivered to the output 224 of the rectifier stage 210 to be used for the load.

As an example, the drive circuit 318 can be implemented in a separate IC that may or may not include the clamping switch N_{FB}. As a first example, the drive circuit 318 can be configured to provide the activation signal ACT at a fixed frequency. As a second example, the drive circuit 318 can be configured to provide the activation signal ACT at a frequency that is proportional to the frequency of the switching signals that are provided to the switching stage of the power supply circuit (e.g. the input switching signals S_{IN1}, S_{IN2}, S_{IN3}, and S_{IN4} provided to the switching stage 202 in the example of FIG. 2). Additionally, the duty-cycle of the activation of the clamping switch N_{FB} can be fixed in each activation/deactivation cycle of the clamping switch N_{FB}. Therefore, the switching of the clamping switch N_{FB} can be provided synchronously or asynchronously with the input switches in the switching stage to provide the clamping current I_{CLMP} to the output 316.

As described above, the clamping current path circuit can be modeled as a synthetic resistor to provide the clamping current from the clamping capacitor C_{CLMP} to the output 316. In the example of the clamping current path circuit provided as the flyback converter demonstrated in FIG. 3, the synthetic resistor can have a resistance value that is set as a function of the inductance of the flyback inductor L_{FB}, the switching frequency of the activation signal ACT, and the duty-cycle of the activation signal ACT. Accordingly, the flyback converter can be configured to be self-regulating to maintain the clamping voltage V_{CLMP} at a constant amplitude, thereby balancing the energy provided to and from the clamping capacitor C_{CLMP}.

As an example, in response to an increase in the voltage V₂, such as in response to an increase in the voltage provided at the primary winding L_{PRI} of the transformer 304, the clamping voltage V_{CLMP} can correspondingly increase. However, an increase in the clamping voltage V_{CLMP} based on additional energy provided to the clamping capacitor C_{CLMP} results in a corresponding proportional increase in the clamping current I_{CLMP} that removes energy from the clamping capacitor C_{CLMP}. Accordingly, the circuit components of the flyback converter can be selected to balance the energy stored in the clamping capacitor C_{CLMP}, such that the flyback converter does not need complicated control schemes or even feedback control to provide the clamped energy to the output 316.

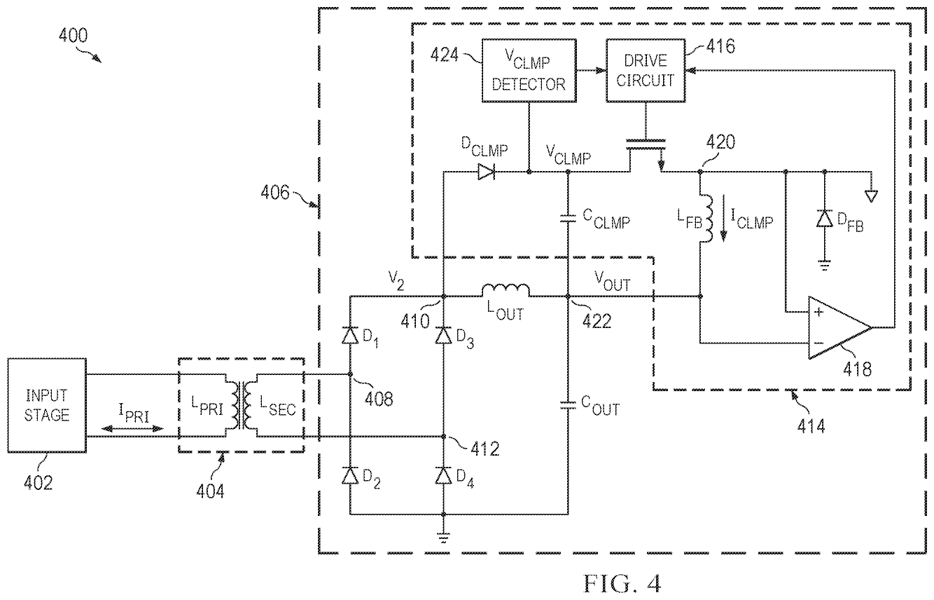

FIG. 4 is another example of a circuit diagram of a power supply system 400. The power supply system 400 can be configured to generate an output voltage V_{OUT} based on an input voltage V_{IN}. The power supply system 400 can be used to implement the power supply system 100 in the example of FIG. 1. Therefore, reference is to be made to the example of FIG. 1 in the following description of the example of FIG. 4.

The power supply system 400 includes a switching stage 402 and a transformer 404. The switching stage 402 can be arranged substantially similar to the switching stage 202 in the example of FIG. 2. Therefore, the switching stage 402 can be arranged as a full bridge switching stage that includes four input switches that are alternately activated in pairs to provide the primary current I_{PRI} through the primary winding L_{PRI} of the transformer 404 in a first direction during a first time duration and in a second direction during a second time duration.

The power supply system 400 also includes a rectifier stage 406. Similar to the rectifier stage 210 in the example of FIG. 2, the rectifier stage 406 includes a first rectifier diode D₁, a second rectifier diode D₂, a third rectifier diode D₃, and a fourth rectifier diode D₄ that are formed as a full-bridge rectifier. The first rectifier diode D₁ interconnects (anode to cathode) a terminal 408 that is coupled to the secondary winding L_{SEC} of the transformer 404 and a terminal 410. The terminal 410 is also coupled to an output inductor L_{OUT} that is configured to conduct an output current I_{OUT}. The second rectifier diode D₂ interconnects the terminal 408 and a low-voltage rail (e.g., a ground terminal). The third rectifier diode D₃ interconnects a terminal 412 that is coupled to the secondary winding L_{SEC} of the transformer 404 and the terminal 410. The fourth rectifier diode D₄ interconnects the low voltage rail and the terminal 408.

The first and fourth rectifier diodes D₁ and D₄ and the second and third rectifier diodes D₂ and D₃ alternately conduct the secondary current I_{SEC} from the secondary winding L_{SEC} to the output inductor L_{OUT}. During a first time duration, the first rectifier diode D₁ and the fourth rectifier diode D₄ conduct the secondary current I_{SEC} from the secondary winding L_{SEC}. Therefore, during the first time duration, the secondary current I_{SEC} is provided as a first rectifier current I_{SR1} from the low voltage rail, through the fourth rectifier diode D₄, through the secondary winding L_{SEC} in a first polarity, and through the first rectifier diode D₁ to the terminal 408. During a second time duration, the third rectifier diode D₃ and the second rectifier diode D₂ conduct the secondary current I_{SEC} from the secondary winding L_{SEC}. Therefore, during the second time duration, the secondary current I_{SEC} is provided as a second rectifier current I_{SR2} from the low voltage rail, through the second rectifier diode D₂, through the secondary winding L_{SEC} in a second polarity opposite the first polarity, through the third rectifier diode D₃, to the terminal 408. The first and second time durations of the rectifier stage 406 can approximately coincide with first and second time durations of the switching stage 402, respectively. The secondary current I_{SEC} can thus be provided through the output inductor L_{OUT} to provide an output voltage V_{OUT} across an output capacitor C_{OUT}. The output voltage V_{OUT} can thus power a load (not shown).

In the example of FIG. 4, the rectifier stage 406 further comprises an active clamping circuit 414 that includes a clamping diode D_{CLMP}, a clamping capacitor C_{CLMP}, and a clamping current path circuit, demonstrated in the example of FIG. 4 as a flyback converter, similar to the example of FIG. 3. The flyback converter includes a clamping switch N_{FB}, a flyback inductor L_{FB}, a flyback diode D_{FB}, and a drive circuit 416. Therefore, the active clamping circuit 414 can operate substantially the same as described above regarding the example of FIG. 3.

In order to mitigate potential harm in the circuit, it may be desirable to operate the flyback converter in a discontinuous conduction mode (DCM) to ensure that current in the flyback inductor L_{FB} does not increase to a destructive amplitude. As an example, under certain conditions (e.g., startup or output overload), the output voltage V_{OUT} may have too low of an amplitude to allow the clamping current I_{CLMP} in the flyback inductor L_{FB} to decay to zero, thus operating in a continuous conduction mode (CCM). In the example of FIG. 4, the active clamping circuit 414 also includes a comparator 418 that is configured to monitor a voltage across the flyback inductor L_{FB}. The comparator 418 includes a first input (non-inverting) that is coupled to a terminal 420 and a second input (inverting) coupled to an output 422 of the rectifier stage 406, and thus across the flyback inductor L_{FB}. The comparator 418 is configured to provide a comparison signal CMP to the drive circuit 416 to control the drive circuit 416.

As an example, in response to detecting that there is a voltage across the flyback inductor L_{FB}, and thus a portion of the clamping current I_{CLMP} remaining in the flyback inductor L_{FB}, the comparator 418 can provide the comparison signal CMP at a first state to disable the drive circuit 416, thereby prohibiting the drive circuit 416 from activating the clamping switch N_{FB}. Therefore, the clamping current I_{CLMP} can continue to flow from the terminal 420 to the output 422 until achieving an amplitude of approximately zero. In response to detecting that there is approximately zero voltage across the flyback inductor L_{FB}, and thus approximately zero amplitude of the clamping current I_{CLMP} in the flyback inductor L_{FB}, the comparator 418 can provide the comparison signal CMP at a second state to enable the drive circuit 416. Therefore, the drive circuit 416 can provide the activation signal ACT to activate the clamping switch N_{FB}. As a result, the comparator 418 can ensure that the flyback converter operates in DCM, and not in a continuous current mode (CCM) that may result in damage to the circuit.

In addition, in the example of FIG. 4, the active clamping circuit 414 includes a clamping voltage detector (“V_{CLMP} DETECTOR”) 424. The clamping voltage detector 424 is configured to monitor an amplitude of the clamping voltage V_{CLMP} and to control the drive circuit 416. As an example, if the rectifier stage 406 is loaded with an approximately fixed resistance, the clamping voltage V_{CLMP} is approximately proportional to the voltage across the secondary winding L_{SEC} of the transformer 404, as described above. Additionally, as described above, the flyback converter of the active clamping circuit 414 can operate in a self-regulating manner to balance the energy provided to and from the clamping capacitor C_{CLMP}, thereby providing an approximate constant amplitude of the clamping voltage V_{CLMP}. However, an excessive amplitude of the clamping voltage V_{CLMP} could potentially result from very high amplitudes of the input voltage (e.g., at the primary winding L_{PRI} of the transformer 404), and/or potential fault conditions could provide an excessive amplitude of the clamping voltage V_{CLMP}. Therefore, the clamping voltage detector 424 can allow the active clamping circuit 414 to operate in a closed-loop manner by monitoring the amplitude of the clamping voltage V_{CLMP} to limit the maximum amplitude of the clamping voltage V_{CLMP}. As an example, in response to the clamping voltage detector 424 determining that the clamping voltage V_{CLMP} has exceeded a predetermined threshold, the clamping voltage detector 424 can command the drive circuit 416 to increase the duty-cycle of the activation signal ACT. Therefore, the amplitude of the clamping voltage V_{CLMP} can be reduced to below the threshold amplitude, thereby mitigating potential voltage stress associated with excessive amplitudes of the clamping voltage V_{CLMP}.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

In this description, a device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof. Furthermore, a circuit or device that is described herein as including certain components may instead be configured to couple to those components to form the described circuitry or device. For example, a structure described herein as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be configured to couple to at least some of the passive elements and/or the sources to form the described structure, either at a time of manufacture or after a time of manufacture, such as by an end-user and/or a third-party.

Modifications are possible in the described embodiments, and other embodiments are possible, within the scope of the claims.

What is claimed is:

1. A circuit comprising:
a rectifier having a rectifier output;
an active clamp circuit having a control input, a clamp circuit input, and a clamp circuit output, in which the clamp circuit input is coupled to the rectifier output and the clamp circuit output is coupled to an output of the circuit; and
a drive circuit having a drive output coupled to the control input.

2. The circuit of claim 1, wherein the active clamp circuit includes a clamping current path circuit having a current path input and a current path output, in which the current path input is coupled to the rectifier output and the current path output is coupled to the output of the circuit.

3. The circuit of claim 2, wherein the clamping current path circuit is arranged as a flyback converter having a converter input and a converter output, in which the converter input is coupled to the rectifier output and the converter output is coupled to the clamp circuit output.

4. The circuit of claim 3, wherein the flyback converter is configured to operate in a discontinuous conduction mode to provide a clamping current to the output of the circuit.

5. The circuit of claim 3, wherein the active clamp circuit further includes:
a clamping diode having a clamping anode and a clamping cathode, the clamping anode coupled to the rectifier output; and
a clamping capacitor having a first capacitor terminal and a second capacitor terminal, the first capacitor terminal coupled to the clamping cathode and the second capacitor terminal coupled to the clamp circuit output.

6. The circuit of claim 5, wherein the clamping capacitor is configured to provide a clamping voltage, wherein the converter input is coupled to a first terminal for the flyback converter, in which the flyback converter is configured to provide a clamping current to the output of the circuit responsive to the clamping voltage.

7. The circuit of claim 6, wherein the flyback converter further includes:
a clamping inductor having a first inductor terminal and a second inductor terminal, in which the first inductor terminal is coupled to the output of the circuit and the second inductor terminal is coupled to the rectifier output;
a clamping switch having the control input, a switch input, and a switch output, in which the switch input is coupled to the clamping cathode and the switch output is coupled to the second inductor terminal; and
a flyback diode having a flyback anode and a flyback cathode, in which the flyback anode is coupled to a voltage terminal and the flyback cathode is coupled to the switch output.

8. The circuit of claim 7, wherein the drive circuit is configured to provide an activation signal to the control input, in which the clamping switch is activated responsive to the activation signal to provide the clamping current to the output of the circuit through the clamping inductor, and the rectifier is configured to provide a rectifier current at the rectifier output to an output capacitor coupled to the output of the circuit to provide an output voltage responsive to the clamping current and the rectifier current.

9. The circuit of claim 8, wherein the flyback diode is configured to provide the clamping current from the voltage terminal responsive to deactivation of the clamping switch.

10. The circuit of claim 8, wherein the clamping switch is activated responsive to the activation signal at constant switching frequency.

11. The circuit of claim 8, wherein the rectifier has first and second rectifier inputs, and the circuit further comprises:
a switching stage having a switching stage input and a switching stage output;
a switching controller having a controller output coupled to the switching stage input; and
a transformer having a transformer input and first and second transformer outputs, in which the transformer input is coupled to the controller output, and the first and second transformer outputs are coupled to the first and second rectifier inputs, in which the switching controller is configured to provide a switching signal to the switching stage input, and the clamping switch is activated responsive to the activation signal, the activation signal having a switching frequency proportional to a frequency of the switching signal.

12. The circuit of claim 7, wherein:
the drive circuit has a drive input, and
the flyback converter includes a comparator having a first comparator input, a second comparator input, and a comparator output, in which the first comparator input is coupled to the second inductor terminal, the second comparator input is coupled to the output of the circuit, and the comparator output is coupled to the drive input.

13. The circuit of claim 12, wherein the comparator is configured to control the drive circuit responsive to an amplitude of an inductor voltage.

14. The circuit of claim 7, wherein:
the drive circuit has a drive input, and
the active clamp circuit further includes a voltage detector having a detector input and a detector output, in which the detector input is coupled to the first capacitor terminal and the detector output is coupled to the drive input.

15. The circuit of claim 14, wherein the voltage detector is configured to adjust a switching on-time of the clamping switch responsive to detecting that an amplitude of the clamping voltage exceeds a threshold amplitude.

16. The circuit of claim 1, wherein the rectifier has first and second rectifier inputs, and the circuit further comprises:
a switching stage having a switching stage input and a switching stage output;
a switching controller having a controller output coupled to the switching stage input; and
a transformer having a transformer input and first and second transformer outputs, in which the transformer input is coupled to the controller output, and the first and second transformer outputs are coupled to the first and second rectifier inputs.

17. A circuit comprising:
a rectifier having a rectifier output;
a clamping diode having a clamping anode and a clamping cathode, the clamping anode coupled to the rectifier output;
a clamping capacitor having a first capacitor terminal and a second capacitor terminal, in which the first capacitor terminal coupled to the clamping cathode, in which the second capacitor terminal is coupled to an output of the circuit; and
a flyback converter, the flyback converter comprising:
a clamping inductor having a first inductor terminal and a second inductor terminal, in which the first inductor terminal is coupled to the output of the circuit and the second inductor terminal is coupled to a clamping switch output;
a clamping switch having a control input, a switch input, and a switch output, in which the switch input is coupled to the clamping cathode and the switch output coupled to the second inductor terminal; and
a flyback diode having a flyback anode and a flyback cathode, in which the flyback anode is coupled to an input voltage terminal and the flyback cathode is coupled to the clamping switch output.

18. The circuit of claim 17, further comprising a drive circuit having a drive output coupled to the control input.

19. The circuit of claim 18, wherein the clamping switch is activated responsive to an activation signal to provide a clamping current to the output of the circuit through the clamping inductor, and the rectifier is configured to provide a rectifier current at the rectifier output to an output capacitor coupled to the output of the circuit to provide an output voltage responsive to the clamping current and the rectifier current.

20. The circuit of claim 18, wherein the clamping switch is activated responsive to an activation signal at constant switching frequency.

21. The circuit of claim 18, wherein the drive circuit has a drive input, in which the circuit includes a comparator having a first comparator input, a second comparator input, and a comparator output, in which the first comparator input is coupled to the second inductor terminal, the second comparator input is coupled to the output of the circuit, and the comparator output is coupled to the drive input.

22. The circuit of claim 18, wherein the drive circuit has a drive input, in which the circuit includes a voltage detector having a detector input and a detector output, in which the detector input is coupled to the first capacitor terminal and the detector output is coupled to the drive input.

23. A circuit comprising:
a switching stage having a switching stage input and a switching stage output;
a switching controller having a controller output coupled to the switching stage input;
a transformer having a transformer input and first and second transformer outputs, in which the transformer input is coupled to the controller output;
a rectifier having a first rectifier input, a second rectifier input, and a rectifier output, in which the first and second rectifier inputs are coupled to the first and second transformer outputs;
an active clamp circuit having a control input, a clamp circuit input, and a clamp circuit output, in which the clamp circuit input is coupled to the rectifier output and the clamp circuit output is coupled to an output of the circuit; and
a drive circuit having a drive output coupled to the control input.

24. The circuit of claim 23, wherein the active clamp circuit includes a flyback converter having a converter input and a converter output, in which the converter input is coupled to the rectifier output and the converter output is coupled to the clamp circuit output.

25. The circuit of claim 24, wherein the flyback converter further includes:
a clamping inductor having a first inductor terminal and a second inductor terminal, the first inductor terminal coupled to the output of the circuit;
a clamping switch having the control input, a switch input, and a switch output, the switch input coupled to a diode output and a first capacitor terminal and the switch output coupled to the second inductor terminal; and
a flyback diode having a flyback input and a flyback cathode, the flyback input being coupled to a low-voltage rail and the flyback cathode being coupled to the switch output and the second inductor terminal.

26. The circuit of claim 25, wherein the clamping switch is activated responsive to an activation signal at constant switching frequency.

27. The circuit of claim 25, wherein the switching controller is configured to provide a switching signal to the switching stage input, in which the clamping switch is activated responsive to an activation signal, the activation signal having a switching frequency proportional to a frequency of the switching signal.
